(19) United States
(12) Patent Application Publication
(10) Pub. No.: US 2024/0159942 A1
(43) Pub. Date: May 16, 2024

(54) TWO-DIMENSIONAL INDIVIDUALLY ADDRESSABLE ELECTROWETTING MICRO-LENS ARRAY

(71) Applicant: The Regents of the University of Colorado, a body corporate, Denver, CO (US)

(72) Inventors: Juliet T. Gopinath, Boulder, CO (US); Samuel D. Gilinsky, Boulder, CO (US); Mo Zohrabi, Longmont, CO (US); Victor M. Bright, Boulder, CO (US); Omkar D. Supekar, Painted Post, NY (US); Wei Yang Lim, Eden Prairie, MN (US)

(73) Assignee: The Regents of the University of Colorado, a body corporate, Denver, CO (US)

(21) Appl. No.: 18/508,114

(22) Filed: Nov. 13, 2023

Related U.S. Application Data
(60) Provisional application No. 63/424,846, filed on Nov. 11, 2022.

(51) Int. Cl. G02B 3/00; G02B 3/14; G02F 1/29

(52) U.S. Cl. CPC G02B 3/0056; G02B 3/14; G02F 1/294

(57) ABSTRACT

A microlens array includes a bottom electrode chip, a sidewall electrode chip, and a top glass chip configured to cooperate to define an array of cavities, each one of the array of cavities containing a fluid. The fluid is a mixture of a polar liquid and a non-polar liquid, in contact with one of the array of sidewalls at a contact angle. The bottom electrode chip includes a plurality of electrical contacts. The sidewall electrode chip includes an array of sidewalls, each including an electrode layer and an insulator layer. When a voltage is applied across the fluid contained a cavity via electrical contacts and the electrode layer of the cavity, the contact angle of the fluid with the sidewall is modified, in embodiments without affecting the contact angle of fluid contained in other ones of the plurality of array of cavities.

### REFERENCE TO RELATED APPLICATIONS

The present application claims the benefit of U.S. Provisional Pat. App. No. 63/424,846, filed 2022 Nov. 11 and titled “Two-Dimensional Individually Addressable Electrowetting Micro-Lens Array,” which application is incorporated hereby in its entirety by reference.

### SPONSORED RESEARCH AND DEVELOPMENT

This invention was made with government support under grant numbers NS116241, awarded by the National Institutes of Health, N00014-20-1-2087 awarded by the Office of Naval Research, and 1926668 awarded by the National Science Foundation. The government has certain rights in the invention.

This work was also supported in part by the U.S. Department of Energy (DOE), Office of Science, Office of Workforce, 288 Development for Teachers and Scientists (WDTS) under 289 Science Undergraduate Laboratory Internships program. Further, this work was performed, in part, at the Center for Integrated Nanotechnologies, an Office of Science User Facility operated for the DOE, Office of Science, by Los Alamos National Laboratory (Contract 89233218CNA000001) and Sandia National Laboratories (Contract DE-NA-0003525).

### FIELD OF THE INVENTION

The present invention relates to microlens arrays and, more specifically, to a microlens array based on electrowetting technology.

### DESCRIPTION OF RELATED ART

A variety of applications require microlens arrays of various lens sizes and array dimensions. Microlens arrays are generally formed of transparent materials that have been formed into fixed arrays of microlenses, which arrays themselves are in turn fixed in dimensions. For example, microlens arrays may be formed of materials such as fused silica or transparent polymers, with each lens being configured to provide specific optical characteristics, such as focal length and aperture size.

In contrast, adaptive or tunable lenses may be used to provide flexible optical characteristics that may be adjusted and tuned according to specific use case scenarios.

For instance, electrowetting technology can be used to provide tunable optical components, such as tunable lenses, beam steering devices, and optical shutters at the macro scale (e.g., on the order of multiple millimeters or larger).

Electrowetting cells and uses thereof have been previously described (see, for example, [1] U.S. Pat. No. 10,598,919 B2, issued 2020 Mar. 24 and titled “Electrowetting-Actuated Optical Shutters,” which is incorporated herein in its entirety by reference). While electrowetting-based devices are individually useful at these macro scales, it is difficult to produce and control arrays of electrowetting devices without compromising tunability. For instance, while oil-based electrowetting display devices exist, such devices have a variety of shortcomings, such as asymmetry in the electrowetting effect and difficulty in obtaining a high contrast display (see, for example, [2]).

Improvements are needed to enable the use of electrowetting techniques at scales beyond a single macro device.

### SUMMARY OF THE INVENTION

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In an embodiment a microlens array includes a bottom electrode chip, a sidewall electrode chip, and a top glass chip. The bottom electrode chip, the sidewall electrode chip, and the top glass chip are configured to cooperate to define an array of cavities. Each one of the array of cavities contains a fluid, such that the fluid is in contact with one of the array of sidewalls at a contact angle. In embodiments, the fluid is a mixture of a polar liquid and a non-polar liquid. The bottom electrode chip includes a plurality of electrical contacts. The sidewall electrode chip includes an array of sidewalls, each one of the array of sidewalls including an electrode layer and an insulator layer. The plurality of electrical contacts and the electrode layer are configured to cooperate such that, when a voltage is applied across the fluid contained In one of the array of cavities via one of the plurality of electrical contacts and the electrode layer corresponding with that one of the array of cavities, the contact angle of the fluid with the sidewall of that one of the array of cavities is modified.

In embodiments, by applying the voltage across the fluid contained in that one of the plurality of the array of cavities, the contact angle of the fluid with the sidewall of that one of the array of cavities is modified without affecting the contact angle of fluid contained in other ones of the plurality of array of cavities. In certain embodiments, by applying the voltage across the fluid contained in that one of the plurality of the array of cavities, an effective focal length of the fluid contained in that one of the plurality of the array of cavities is modified, without affecting the effective focal length of fluid contained in other ones of the plurality of array of cavities.

In embodiments, the bottom electrode chip and the top electrode chip are formed of a transmissive material.

In embodiments, the plurality of electrical contacts of the bottom electrode chip are configured to cooperate with the sidewall electrode chip to enable individual addressing of the fluid in each one of the array of cavities. In certain embodiments, the plurality of electrical contacts of the bottom electrode chip are patterned such that one contact pad is associated with each one of the array of cavities.

In embodiments, the sidewall electrode chip is formed from a photo-patternable glass. In certain embodiments, each one of the array of sidewalls is formed to be substantially perpendicular to a top surface of the photo-patternable glass. In certain embodiments, the system further includes a hydrophobic coating on the array of sidewalls.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 is a perspective view of an example electrowetting microlens array, in accordance with an embodiment.

FIG. 2 is a cross-sectional view of a fabricated 500 μm diameter electrowetting microlens array, in accordance with an embodiment.

FIG. 3 is a top view of a patterned electrical connections for individual microlens actuation, in accordance with an embodiment.

FIG. 4 is a close-up view of contact pads for microlens actuation, in accordance with an embodiment.

FIG. 5 is a partial perspective view of a side electrode chip, showing details of an array of 500 μm diameter etched cavities for containing the polar and non-polar liquids therein, in accordance with an embodiment.

FIG. 6A shows a fully assembled electrowetting microlens array system.

FIG. 6B shows a 3-by-3 array of 500 μm diameter microlenses.

FIG. 6C shows an inset of the 3-by-3 array of FIG. 6B, shown here to include magnified views of individual actuation of two of the microlenses in the array, in accordance with an embodiment.

FIG. 7 shows a block diagram of an exemplary actuation system for operating an array of electrowetting microlens array, in accordance with an embodiment.

FIG. 8 shows a 4f imaging system used in characterizing the focal length tunability of an EWOD microlens array, in accordance with an embodiment.

FIG. 9 shows a plot comparing the experimental and theoretical focal length tunability of an electrowetting microlens array device, in accordance with an embodiment.

FIG. 10 is an illustration of an exemplary EWOD liquid-liquid system contained within a tubular geometry for use in Navier Stokes modeling, in accordance with an embodiment.

FIG. 11 shows a plot of the calculated z-coordinate of the liquid-liquid meniscus apex point over time as the contact angle of the liquids is changed in the simulation, in accordance with an embodiment.

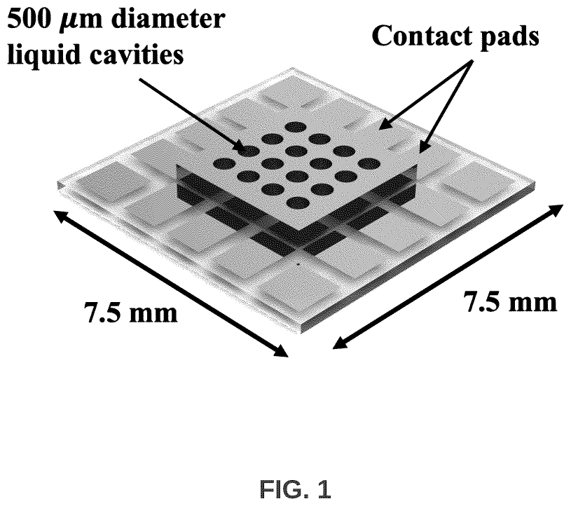

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

### DETAILED DESCRIPTION OF THE INVENTION

Electrowetting lenses are based on the electrowetting-on-dielectric (EWOD) effect, in which an applied electric field is used to tune the surface tension of a solid-liquid interface [3]. In particular, the EWOD effect may be used to change the contact angle of a liquid droplet by applied electric field. When a conductive droplet is placed on a dielectric coating on a metal substrate and a potential is applied between the conductive droplet and the metal substrate, a cloud of counter ions in the droplet accumulates on the liquid-dielectric interface. This charge cloud creates a capacitive force and a corresponding surface tension imbalance at the contact point. The contact angle of the droplet changes to counteract this imbalance. This change in droplet contact angle with applied voltage is governed by the Lippman Young equation and is dependent on the liquid/dielectric surface tension, dielectric permittivity, and dielectric thickness

An example device may utilize the EWOD effect by providing a cylindrical glass cavity containing an electrode and dielectric layer attached to a base optical window (i.e., bottom window) with a ground electrode. The glass cavities may be filled with two immiscible liquids, where one liquid is a polar liquid such as deionized (DI) water and the other liquid is a non-polar liquid such as 1-phenyl-1-cyclohexene (PCH), thus defining a liquid-liquid interface between the polar and non-polar liquids. The combination of DI water and PCH as the polar and non-polar liquid combination may be particularly attractive for certain embodiments as these materials exhibit a wide range of contact angle tunability, as well as a high refractive index contrast of approximately 0.2.

When a voltage is applied between the electrodes on the bottom window and sidewalls of the cavity, the effective contact angle of the polar droplet changes with an applied voltage such that the curvature of a meniscus at the liquid-liquid interface exhibits a corresponding change. If there is an index of refraction contrast between the two liquids, the liquid interface behaves like a lens and the change in meniscus curvature results in a change in effective focal length. That is, the contrast between the indices of refraction of the polar and non-polar liquids and the ability to modify the curvature of the liquid-liquid interface enables the device to act essentially as a tunable lens with variable optical properties, such as focal length and phase.

The electrowetting effect may be used to form tunable electrowetting optical devices. These devices have the benefit of being compact, low power consumption, transmissive and entirely nonmechanical. Fluidic single lens devices based on the electrowetting effect have recently been demonstrated in applications such as beam-steering [4], aberration control [5, 6], and biomedical imaging [7]. That is, these devices are particularly attractive due to their transmissive nature, low power consumption, and large range of tunability [8, 9] without mechanical moving parts. Previous work in electrowetting devices have focused, for example, on optimizing the initial contact angle of the liquid contained within a single cell (e.g., a combination of deionized (DI) water and 1-Phenyl-1-cyclohexene (PCH) contained within a cavity coated in a 600 nm of 10% weight CYTOP™ fluoropolymer hydrophobic solution has previously been shown to result in a 173° initial contact angle inside each lens cavity [10]).

However, the devices demonstrated thus far have been limited to single cell devices. While arrays of electrowetting devices have been contemplated [2, 11], they have been generally been demonstrated in compact, practical formats due to the particular requirements of the containment of two compatible liquids in each cell. For example, while a single cell liquid crystal-based device may be operated as an array by providing patterned electrodes to modify the optical properties of only a small portion of the cell at a time, a single cell electrowetting device cannot be operated in a similar manner. Such limitations of electrowetting devices limit the usefulness of previously demonstrated electrowetting microlens arrays.

Embodiments of the present disclosure provide individually addressable, micro-scale array of electrowetting microlenses. In certain examples, the electrowetting microlenses are provided in a standard electronic chip package, manufactured using standard electronics microfabrication techniques. Since each microlens can be addressed individually, these arrays open the possibility for further applications in transmissive wavefront shaping, integration into miniature optical systems, and fast, tunable phase arrays for optical encryption.

Potential applications include compact imaging systems, such as biomedical imaging and light-field cameras, wavefront control, such as optical encryption and aberration correction, and microscopy. For example, a static microlens array may be used to increase scan rate and resolution in a multi-photon fluorescence neuronal imaging microscope by scanning the point field created by the microlens array around the sample field of view. Integration of an electrowetting microlens array could allow for an adaptive way of changing the imaging depth as well as even potentially perform the scanning itself. As another example, optical encryption using a liquid surface may be used to add a controllable phase shape to an incident wavefront. The integration of an individually addressable electrowetting microlens array may perform a similar function by changing the phase of a plurality of discrete points in an incident wavefront.

In an embodiment, certain requirements are taken into consideration when fabricating the microlens arrays. For instance, in transmissive operation of electrowetting microlenses, a substantial portion of the device should be formed of glass. Further, to enable individual addressing of each microlens, individual electrical connections are patterned while isolating neighboring lenses from each other. Additionally, a large tunability range as well as a short response time would be desirable in the device performance. Further, it is desirable to manufacture the microlens array using standard microfabrication processes.

In an embodiment, the microlens array is formed of three separately fabricated chips: 1) a bottom electrode chip; 2) a sidewall electrode chip; and 3) a top glass chip used to seal the liquids in the microlens array. For example, a microlens array design may utilize three separately fabricated chips: a bottom glass chip containing electrical contacts needed for individual actuation, a photo-patternable glass chip (Schott Foturan II®) used as both the vertical cylindrical cavities and sidewall electrodes at equipotential, and a top glass chip for sealing the liquids in our device. These chips may then be bonded together to assemble the final device. For use as a transmissive array, the bottom electrode chip and the top glass chip may be formed of a transmissive material.

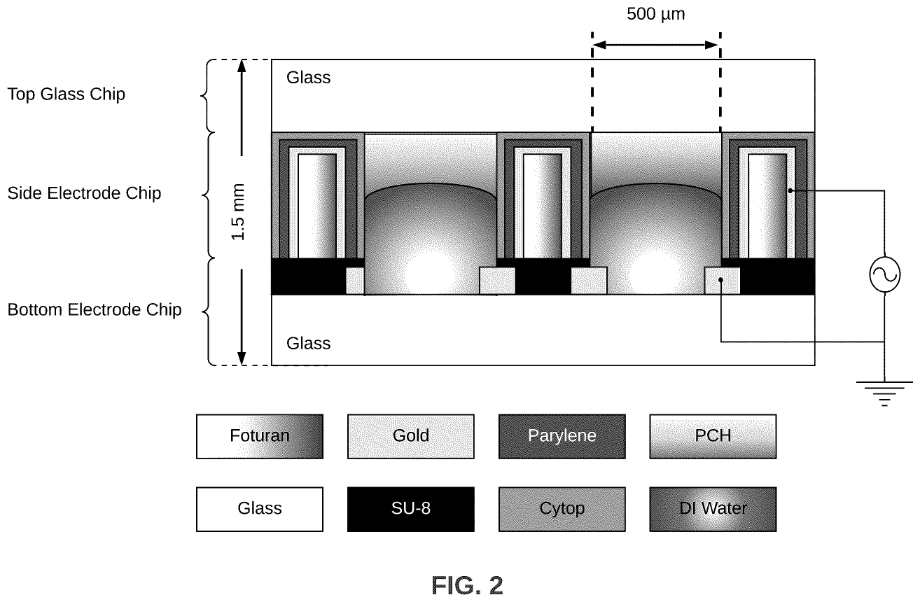

A cross section of a 1.5 mm thick array design with 500 μm diameter lenses is shown in FIG. 2. A cross-sectional view of a fabricated 500 μm diameter electrowetting microlens array. The side and bottom electrode chips are fabricated separately then bonded together. The device is filled with deionized (DI) water and phenocyclohexane (PCH) and a potential is applied between the side and bottom electrodes to actuate each lens individually. The final device is approximately 1.5 mm thick.

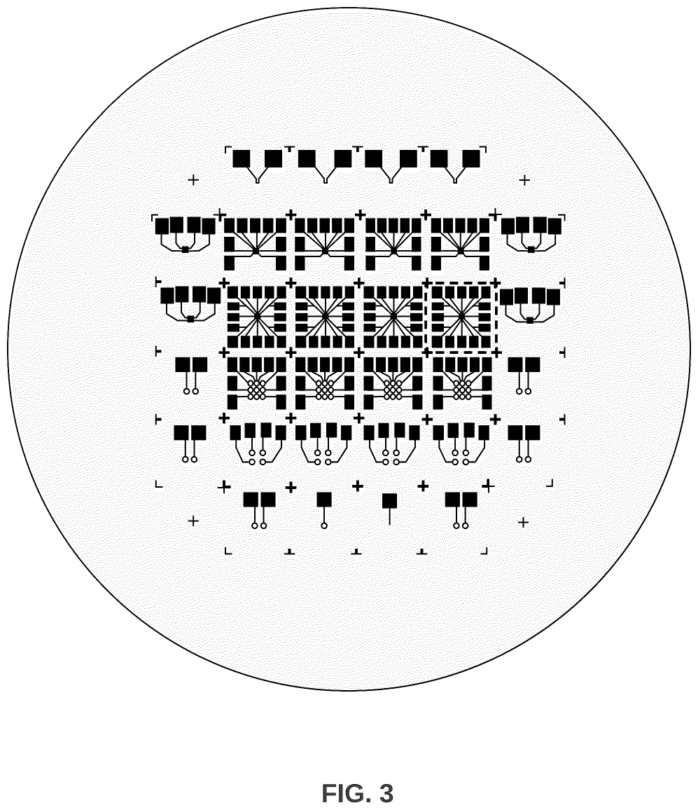

In an embodiment, a bottom electrode chip is formed to individually address each microlens in the electrowetting microlens array. That is, a voltage may be separately provided across the fluid contained in each one of the cavities, formed by the combination of the bottom electrode chip, the side wall electrode chip, and the top glass chip, without affecting the fluid contained in each other one of the cavities. The bottom electrode chips may be formed at a wafer scale, as shown in FIG. 3 in which multiple bottom electrode chips are visible. The individual electrical connections for each cell in the array may be patterned, via photolithography, and coated in gold, via a lift-off process.

In particular, FIG. 3 shows a top view of a patterned electrical connections for individual microlens actuation. The electrodes may be formed by wafer-level fabrication, in accordance with an embodiment. Each chip, indicated by a dashed box, is approximately 7.5 mm by 7.5 mm in dimension.

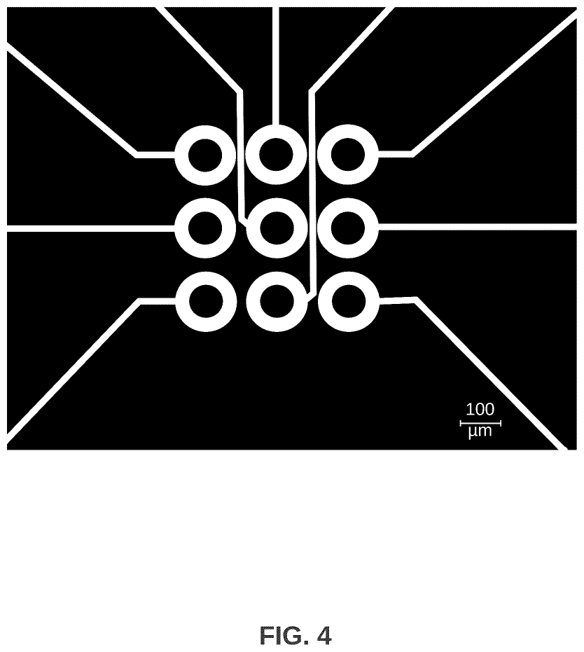

Additionally, FIG. 4 shows a close-up view of contact pads for microlens actuation. The patterned contact pads shown in FIG. 4 may be formed, for example, onto one side of each bottom chip such that each microlens may be connected to a separate contact pad to enable individual microlens actuation. In the illustrated embodiment, the patterned contact pads are formed onto one side of each bottom chip. Each microlens is connected with a separate contact pad to enable individual microlens actuation. In an alternative embodiment, each bottom electrode chip may be separately fabricated, instead of at a wafer scale.

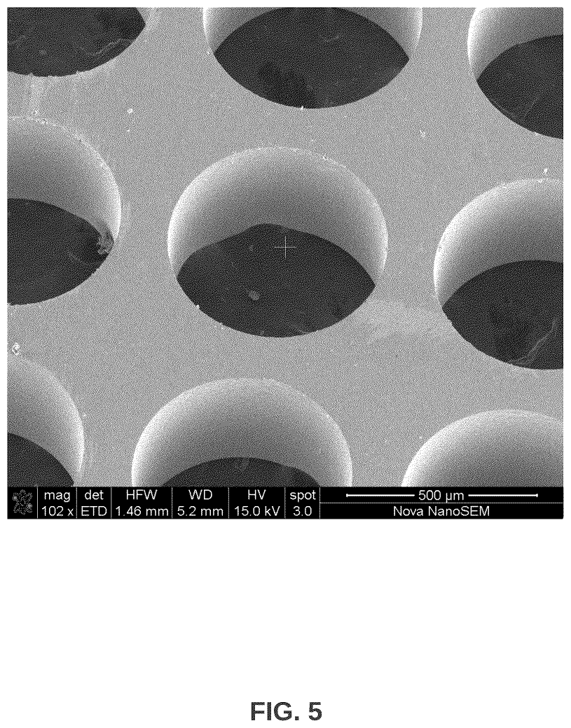

Separately, a sidewall electrode chip is formed to contain the polar and nonpolar liquids as well as create the potential difference between each lens and the walls of each cavity (See FIG. 5). In an embodiment, the sidewall electrode chip is formed from a photo-patternable glass, such as FOTURAN® II photo-structurable glass available from Schott, to achieve high aspect ratio vertical sidewalls for the liquid cavities. That is, in embodiments, the sidewalls are formed to be substantially perpendicular to a top surface of the photo-patternable glass.

In particular, FIG. 5 shows a scanning electron micrograph (SEM) image, in a partial perspective view, of a side electrode chip shown here as an etched 3-by-3 array of 500 μm diameter cavities in FORTURAN® II photo-structurable glass. In an embodiment, this etched chip is uniformly coated with a gold electrode material, a dielectric layer (e.g., PARYLENE HT® conformal coating available from Special Coating Systems), and a hydrophobic coating to increase the initial contact angle of the polar liquid. For instance, the liquid cavities may be etched into FORTURAN® II photo-structurable glass, then coated with an electrode layer, dielectric layer, and a hydrophobic coating, resulting in etched cavities with smooth surfaces and high aspect ratio. In an alternative embodiment, individual liquid cavities may be machined in a substrate with sufficiently smooth surface roughness so as to prevent pinning of the liquids in each liquid cavity.

In an example device assembly process, bottom and side electrode chips are bonded together using an intermediate layer of a negative photoresist (e.g., SU-8 photoresist available from Kayaku Advanced Materials). The photoresist layer is patterned and developed over each individual lens electrode. In an embodiment, the chips are heated to the transition temperature of cross-linked photoresist (i.e., 175° C. for SU-8 photoresist), then approximately 2 M Pa of pressure is applied to the assembled device for one hour. This process results in a strong seal to confines the liquids within each individual lens cavity, which is essential for enabling individual actuation of the microlenses.

In an embodiment, each one of the resulting micro-cavities is filled with approximately same volumes of a polar liquid and a non-polar liquid (e.g., DI water and PCH) using a microdrop dispenser (such as available from microdrop Technologies GMBH), which uses a piezoelectric actuator and a glass capillary to deposit specified amounts of liquid at the picoliter scale. In an embodiment, for 500 μm cavity height and diameter this equates to approximately 49 nanoliters of both deionized water and PCH. The microdrop dispenser may be attached to a commercial 3D printer and aligned remotely over each microlens cavity in the array. To avoid rapid evaporation, devices may be filled in a raised humidity chamber.

It is noted that other liquids and combinations thereof may be suitable for use in electrowetting microlens arrays, and such alternatives are considered a part of the present disclosure. Additionally, any electrowetting liquids may be suitable for use in an electrowetting microlens array, in embodiments, particularly those materials that are immiscible, provide high index contrast, high surface tension, is preferably non-toxic, and is transmissive for light of a wavelength window of interest. A variety of different polar and non-polar liquid combinations may be contemplated, such as a combination of water and silicone oil, deionized water and PCH, other room temperature ionic liquids (RTILs) and PCH, and others. For example, room temperature ionic liquids may be suitable for use as lenses in the infrared wavelengths. Another example may be combinations of a refractive index liquid (e.g., laser liquids such as Cargille Liquid code 433) and a polar liquid. Other liquid combinations have been studied (see, for example, [12]). Additionally, electrolytic solutions may be employed to lower the required actuation voltage of the liquid-liquid interface.

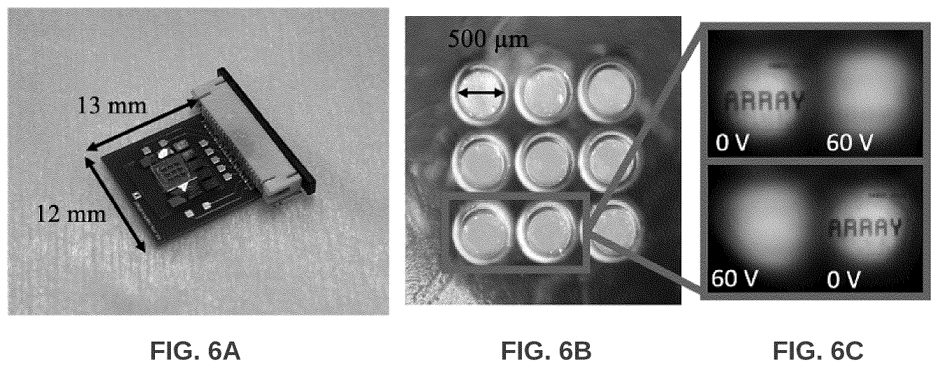

Individual actuation of a single lens in a 3-by-3 500 μm diameter lens array is shown in FIGS. 6A-6C. In the example illustrated in FIGS. 6A-6C, a fully assembled electrowetting microlens array, printed circuit board to drive the devices, and a magnified view of actuation of a 500 μm diameter 3×3 array.

More particularly, FIG. 6A shows a fully assembled electrowetting microlens array system. FIG. 6B shows a magnified view of the 3-by-3 array of 500 μm diameter microlenses from the system of FIG. 6A. FIG. 6C shows an inset of the 3-by-3 array of FIG. 6B, shown here to include magnified views of individual actuation of two of the microlenses in the array, in accordance with an embodiment. As may be seen in FIG. 6C, a top portion of FIG. 6C shows the actuation of the right one of the two microlenses shown, by application of 60 V voltage in that cavity, while no voltage is applied to the left one of the two microlenses. Conversely, a bottom portion of FIG. 6C shows the actuation of the left one of the two microlenses, while the right microlens is not activated. In this way, the individual addressing of each microlens may be seen by the word “ARRAY” being brought into focus by the actuation of a specific microlens.

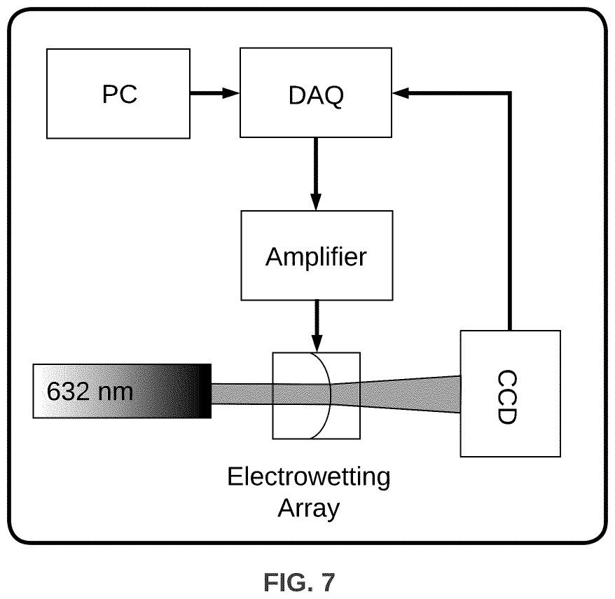

The assembled microlens array device may be wire-bonded to a custom PCB to provide connection between a pin connector and the individually patterned electrodes, which allows for individual actuation from a multi-channel amplifier, such as shown in FIG. 7. In the exemplary actuation system shown in FIG. 7, a personal computer (PC) may be used to control a data acquisition system (DAQ), which in turn controls an amplifier (such as an OKO Technologies amplifier). The electrowetting microlens array is illuminated with a 632 nm laser beam, and the transmitted output is collected at a Charge Coupled Device (CCD). The detected output at the CCD is collected at the DAQ for analysis. As shown in FIG. 7, each individual lens may be provided with a unique analog voltage input, which is amplified through a multi-channel amplifier and sent to the microlens array device.

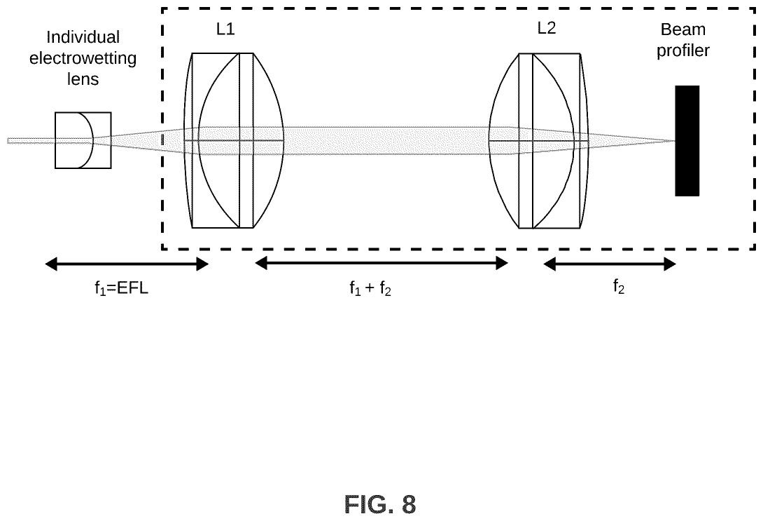

A 4f imaging system, as shown in FIG. 8, may be used to characterize the focal length tunability of an embodiment of the microlens array as described above. In particular, the 4f system may be translated to achieve a minimum spot size on the detector/beam profiler, which location corresponds to an effective focal length (EFL) of the microlens array being located at a back focal length (BFL) of lens 1 (L1). In an example analysis, a 632 nm wavelength collimated signal from a laser source is transmitted through one cell within the microlens array. In an embodiment, each microlens in the EWOD microlens array operates as a highly divergent lens, and the 4f system images the focal plane onto a beam profiler, as shown in FIG. 8. The microlens array and the 4f system are then translated with respect to each other to optimize the focal spot measured on the beam profiler.

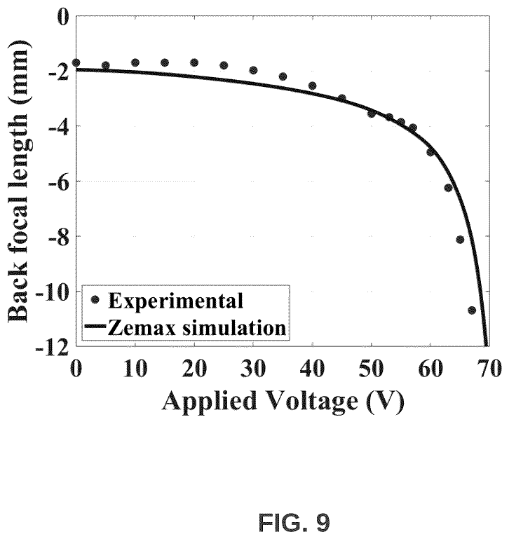

As increasing voltage is uniformly applied to each microlens in the microlens array, the change in contact angle of the meniscus results in a change of effective focal length and a corresponding change in the optimized position of our imaging system. In an example, an optimal profile for the focal spot may be obtained when the back focal length of L1 is located at the effective focal position of the particular microlens being characterized. From this measurement, the back focal length of the microlens may be characterized as a function of applied voltage. The distance from the 4f system to the top of our electrowetting arrays is subtracted from the back focal length of the first lens to obtain an approximation for a back focal length of each electrowetting lens as a function of applied voltage, shown as dots in FIG. 9.

Particularly, FIG. 9 shows a comparison of the experimental and theoretical focal length tunability of an electrowetting microlens array device. With increasing applied voltage of 0 V to 75 V, a theoretical focal length change (shown as a curve) from −1.7 mm to infinity, with good agreement with experimental results (shown as dots) with device actuation up to 70 V applied voltage. At approximately 75 V actuation, corresponding to 90° liquid meniscus contact angle, the effective focal length of our array approaches infinity. The theoretical results shown in FIG. 9 may be obtained, for example, by modeling the microlens array system in an optical modeling software package, such as ANSYS ZEMAX OPTICSTUDIO™ optical workflow and design software available from ANSYS, Inc.

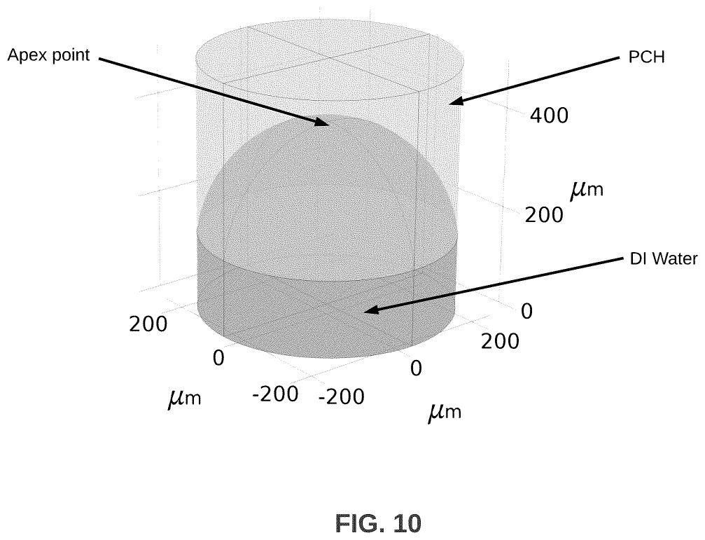

It is noted that, with the reduction in the size of the liquid cavity and, consequently, lens diameter of each microlens, the settle time of the liquid-liquid meniscus may also decrease. As a result, the response time of the EWOD microlens to applied voltage also is reduced. In other words, by reducing the microlens dimensions, a faster response time of the microlens to applied voltage is obtained. In an example characterization of response time, the liquid meniscus settle time may be simulated by solving the Navier Stokes equations for an exemplary EWOD liquid-liquid system, such as shown in FIG. 10. That is, FIG. 10 shows an illustration of an exemplary EWOD liquid-liquid system contained within a tubular geometry for use in Navier Stokes modeling.

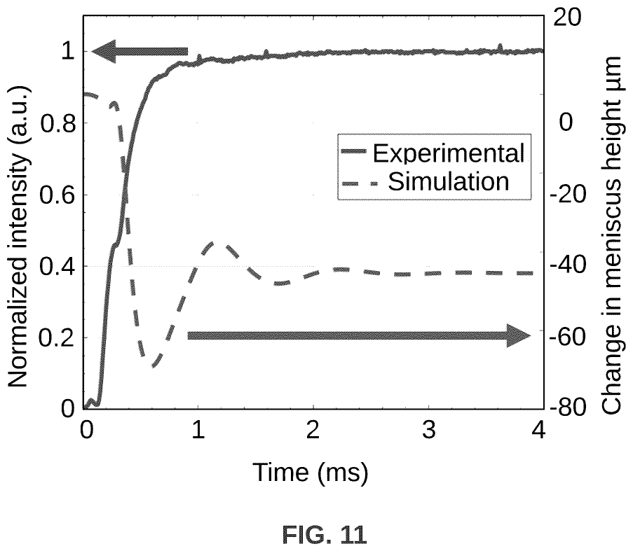

For the geometry illustrated in FIG. 10, the dashed curve in FIG. 11 shows a plot of the z-coordinate of the liquid-liquid meniscus apex point over time, as the contact angle of the liquids from 173 to 153 degrees, calculated by solving the Navier Stokes equations. The plot in FIG. 11 indicates that the liquid system reaches 2% of its final steady state value within 1.5 milliseconds. Simulation results shown by the dashed plot in FIG. 11 have been experimentally verified by directing a 632 nm collimated laser beam through the center of one of the microlenses in the array. In an example, the microlens is actuated to approximately 90 degrees contact angle using an input voltage of 70 V, which focuses the laser beam through a 10× objective, a 50-micron pinhole, and onto a photodetector. As a voltage is applied to this microlens, a standing wave is generated on the liquid-liquid meniscus, which causes an intensity variation of the laser beam measured on the photodetector. Finding the settling time of the intensity variation measured allows for the approximation of the liquid-liquid meniscus response time with an applied voltage. The intensity variation on the photodetector is shown by the solid curve on FIG. 11. These results show good agreement with COMSOL simulations (dashed curve), reaching within 1% of its steady-state value within 1.5 milliseconds.

In summary, herein described are embodiments of an individually addressable electrowetting microlens array fabricated using standard microfabrication techniques capable of focal length tuning. Due to their compact and transmissive nature, these arrays have promising applications for integration into miniature imaging systems and optical phase arrays. Further details of the system and fabrication thereof are also described in publications, which are incorporated herein in their entirety by reference and considered a part of the present disclosure [5, 13, 14]. The embodiments of the microlens array system described herein may be particularly suited for applications such as simultaneous imaging of different regions of interest using a single microlens array, aberration compensation [5], and beam steering for free space communication systems. For example, in biological applications, the microlens array may be used in combination with a microscope to simultaneously monitor multiple regions of a biological sample. Similarly, a combination of the microlens array with a camera may enable simultaneous monitoring of multiple regions.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding”— whether explicitly discussed or not—and, conversely, were there only disclosure of the act of “protruding”, such a disclosure should be understood to encompass disclosure of a “protrusion”. Such changes and alternative terms are to be understood to be explicitly included in the description.

### REFERENCES

[1] J. Gopinath, et al., U.S. Pat. No. 10,598,919 B2, “Electrowetting-Actuated Optical Shutters,” issued 2020 Mar. 24.
[2] Zhang, et al., “Driving Waveform Design of Electrowetting Displays Based on a Reset Signal for Suppressing Charge Trapping Effect,” Front. Phys., 29 Apr. 2021, Sec. Optics and Photonics, 2021.
[3] F. Mugele, et al., “Electrowetting: from basics to applications,” Journal of Physics: Condensed Matter, vol. 17, R705-R774, 2005.
[4] M. Zohrabi, et al., “Wide-angle nonmechanical beam steering using liquid lenses,” Optics Express, vol. 24, 23798-23809, 2016.
[5] M. Zohrabi, et al., “Adaptive aberration correction using an electrowetting array,” Appl. Phys. Lett. 122, 081102, 2023.
[6] M. Zohrabi, et al., “Numerical analysis of wavefront aberration correction using multielectrode electrowetting-based devices,” Optics Express, vol. 25, 31451-31461, 2017.
[7] P. Zhao, et al., “Tunable fluidic lens with a dynamic high-order aberration control,” Applied Optics, vol. 60, 5302-5311, 2021.
[8] O. D. Supekar, et al., “Two-photon laser scanning microscopy with electrowetting-based prism scanning,” Biomedical Optics Express, vol. 8, 5412-5426, 2017.
[9] W. Y. Lim, et al., “Liquid combination with high refractive index contrast and fast scanning speeds for electrowetting adaptive optics,” Langmuir, vol. 34, 14511-14518, 2018.
[10] K. L. Van Grinsven, et al., “Flexible Electrowetting-on-Dielectric Microlens Array Sheet,” Micromachines, vol. 10, 1-13, 2019.
[11] C. Kim, et al., “Fabrication of an electrowetting liquid microlens array for a focus tunable integral imaging system,” Optics Letters, vol. 45, 511-514, 2020.
[12] W. Y. Lim, “Electrowetting-on-Dielectric Tunable Optics for Laser Scanners and Whispering Gallery Mode Resonator,” Ph.D. thesis, Department of Mechanical Engineering, University of Colorado Boulder, 2021.
[13] S. Gilinsky, et al., “Two-dimensional individually addressable electrowetting micro-lens array,” IEEE Photonics Conference (IPC), 2022.
[14] S. Gilinsky, et al., “Fabrication and characterization of a two-dimensional individually addressable electrowetting microlens array,” Optics Express, vol. 31, no. 11, 2023.

1. A microlens array comprising:
a bottom electrode chip;
a sidewall electrode chip; and
a top glass chip,
wherein the bottom electrode chip, the sidewall electrode chip, and the top glass chip are configured to cooperate to define an array of cavities, each one of the array of cavities containing a fluid, the fluid being a mixture of a polar liquid and a non-polar liquid, such that the fluid is in contact with one of the array of sidewalls at a contact angle,
wherein the bottom electrode chip includes a plurality of electrical contacts,
wherein the sidewall electrode chip includes an array of sidewalls, each one of the array of sidewalls including an electrode layer and an insulator layer, and
wherein the plurality of electrical contacts and the electrode layer are configured to cooperate such that, when a voltage is applied across the fluid contained in one of the array of cavities via one of the plurality of electrical contacts and the electrode layer corresponding with that one of the array of cavities, the contact angle of the fluid with the sidewall of that one of the array of cavities is modified.

2. The system of claim 1, wherein, by applying the voltage across the fluid contained in that one of the plurality of the array of cavities, the contact angle of the fluid with the sidewall of that one of the array of cavities is modified without affecting the contact angle of fluid contained in other ones of the plurality of array of cavities.

3. The system of claim 2, wherein, by applying the voltage across the fluid contained in that one of the plurality of the array of cavities, an effective focal length of the fluid contained in that one of the plurality of the array of cavities is modified, without affecting the effective focal length of fluid contained in other ones of the plurality of array of cavities.

4. The system of claim 1, wherein the bottom electrode chip and the top electrode chip are formed of a transmissive material.

5. The system of claim 1, wherein the plurality of electrical contacts of the bottom electrode chip are configured to cooperate with the sidewall electrode chip to enable individual addressing of the fluid in each one of the array of cavities.

6. The system of claim 5, wherein the plurality of electrical contacts of the bottom electrode chip are patterned such that one contact pad is associated with each one of the array of cavities.

7. The system of claim 1, wherein the sidewall electrode chip is formed from a photo-patternable glass.

8. The system of claim 7, wherein each one of the array of sidewalls is formed to be substantially perpendicular to a top surface of the photo-patternable glass.

9. The system of claim 7, further comprising a hydrophobic coating on the array of sidewalls.
